(19) United States
(12) Patent Application Publication
(10) Pub. No.: US 2017/0325145 A1
(43) Pub. Date: Nov. 9, 2017

(54) SYSTEMS AND METHODS FOR DETERMINING COMMUNICATIONS PROTOCOL USAGE BASED ON METRICS

(71) Applicant: Lenovo Enterprise Solutions (Singapore) Pte. Ltd., New Tech Park (SG)

(72) Inventors: Gary D. Cudak, Wake Forest, NC (US); Jennifer J. Lee-Baron, Morrisville, NC (US); Amy L. Rose, Chapel Hill, NC (US); John S. Crowe, Durham, NC (US); Nathan J. Peterson, Oxford, NC (US); Bryan L. Young, Tualatin, OR (US)

(21) Appl. No.: 15/144,923

(22) Filed: May 3, 2016

(51) Int. Cl. H04W 36/26; H04L 12/26; H04W 4/00

(52) U.S. Cl. CPC H04W 36/26; H04W 4/008; H04L 43/0876; H04L 43/16

(57) ABSTRACT

Systems and methods for determining communications protocol usage based on metrics are disclosed. According to an aspect, a method includes communicating with a computing device in accordance with a first communications protocol. The method also includes determining whether a predetermined communications metric is met when communicating with the computing device in accordance with the first communications protocol. Further, the method includes initializing communication with the computing device in accordance with a second communications protocol in response to determining that the predetermined communications metric is met.

### TECHNICAL FIELD

The present subject matter relates to communications. More specifically, the present subject matter relates to systems and methods for determining communications protocol usage based on metrics.

### BACKGROUND

Computing devices utilize various technologies for communicating among one another. A computing device may be capable of communicating with another computing device by use of one or more communications protocols. For example, many smartphones are capable of communicating with another computing device through both BLUETOOTH® technology and WI-FI® technology. BLUETOOTH® technology is known for low-power consumption and a short range based on low cost transceiver microchips in the device. WI-FI® technology may be used for wireless local area network (WLAN) communication at higher power consumption and greater range than BLUETOOTH® technology. Thus, these communications technologies and others have advantages and disadvantages as compared to one another. An operator of a device may manually select to use one of the communications technologies to take advantage of a benefit of the technology. However, it would be beneficial to provide automated techniques for advantageously switching among different communications technologies.

### SUMMARY

Disclosed herein are systems and methods for determining communications protocol usage based on metrics. According to an aspect, a method includes communicating with a computing device in accordance with a first communications protocol. The method also includes determining whether a predetermined communications metric is met when communicating with the computing device in accordance with the first communications protocol. Further, the method includes initializing communication with the computing device in accordance with a second communications protocol in response to determining that the predetermined communications metric is met.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1 is a schematic diagram of a system for determining communications protocol usage based on metrics according to embodiments of the present disclosure; and

FIG. 2 is a flowchart of an example method for determining communications protocol usage based on metrics according to embodiments of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the computing device and achieve the stated purpose of the computing device.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. In another example, the user can use any other suitable user interface of a computing device, such as a keypad, to select the display icon or display object. For example, the user can use a track ball or arrow keys for moving a cursor to highlight and select the display object.

As used herein, the term “memory” is generally a storage device of a computing device. Examples include, but are not limited to, ROM and RAM.

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the term “computing device” should be broadly construed. It can include any type of computing device, for example, a smart phone, a cell phone, a pager, a personal digital assistant (PDA, e.g., with GPRS NIC), a mobile computer with a smartphone client, or the like. A computing device can also include any type of conventional computer, for example, a desktop computer or a laptop computer. A typical mobile device is a wireless data access-enabled device (e.g., an iPHONE® smartphone, a BLACKBERRY® smart phone, a NEXUS ONE™ smart phone, an iPAD™ device, or the like) that is capable of sending and receiving data in a wireless manner using communications protocols such as the Internet Protocol (IP), BLUETOOTH®, WI-FI®, and the wireless application protocol (WAP). This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device.

As referred to herein, a “user interface” is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the presently disclosed subject matter may be implemented are also well-known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or a 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the presently disclosed subject matter may be implemented in other and next-generation mobile networks and devices as well. The mobile device is the physical equipment used by the end user, typically a subscriber to the wireless network. Typically, a mobile device is a 2.5G-compliant device or 3G-compliant device (or the proposed 4G-compliant device) that includes a subscriber identity module (SIM), which is a smart card that carries subscriber-specific information, mobile equipment (e.g., radio and associated signal processing devices), a user interface (or a man-machine interface (MMI), and one or more interfaces to external devices (e.g., computers, PDAs, and the like). The mobile device may also include a memory or data store.

As referred to herein, a “communications protocol” is a system of rules that allow two or more computing devices to transmit data between one another. A communications protocol can set forth rules or standards that defines the syntax, semantics, and synchronization of communication and possible error recovery methods. A communications protocol may be implemented by suitable hardware, software, firmware, or combinations thereof. Example communications protocols include, but are not limited to, BLUETOOTH® communications protocol, WI-FI® communications protocol, or any other suitable types of protocols.

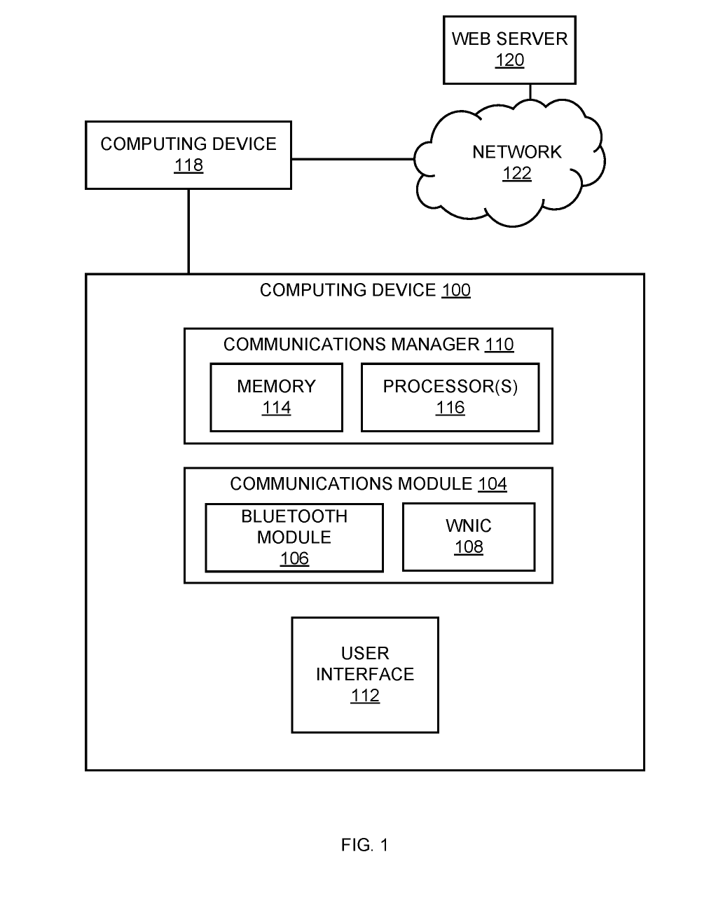

The present disclosure is now described in more detail. For example, FIG. 1 illustrates a schematic diagram of a system for determining communications protocol usage based on metrics according to embodiments of the present disclosure. Referring to FIG. 1, the system includes a computing device 100, which may be any type of computing device capable of communicating with another device. The computing device 100 comprises a number of functional components. This representation of the computing device 100 is meant to be for convenience of illustration and description, and it should not be taken to limit the scope of the presently disclosed subject matter as one or more of the functions may be combined. Typically, these components are implemented by a combination of hardware and software (as a set of process-executable computer instructions, associated data structures, and the like). One or more of the functions may be combined or otherwise implemented in any suitable manner (e.g., in hardware, in firmware, in combined hardware and software, or the like). The computing device 100 may include a graphics rendering engine for displaying information to the end user in the usual manner. The computing device 100 is Internet-accessible and can interact with a web server 102 using known Internet protocols such as HTTP, HTTPS, and the like. The web server 102 is shown as a single device but this is not a requirement either; one or more programs, processes, or other code may comprise the server and be executed on one or more computing devices (in one or more networked locations).

The operation of the system can be described by the following example. As shown in FIG. 1, the computing device 100 includes various functional components and associated data stores to facilitate the operation. The operation of the disclosed methods may be implemented using components other than as shown in FIG. 1.

In this example system, the computing device 100 includes a communications module 104 configured to communicate with another computing device in accordance with two or more communications protocols. For example, the communications module 104 may include a BLUETOOTH® module 106 and a wireless network interface controller (WNIC) 108 for communication in accordance with a BLUETOOTH® communications protocol and a WI-FI® communications protocol, respectively. The computing device 100 also includes a communications manager 110 configured to determine whether a predetermined communications metric is met when the computing device 100 is communicating with another computing device in accordance with one communications protocol. Further, the communications manager 110 is configured to initialize communication with the other computing device in accordance with another communications protocol in response to determining that the predetermined communications metric is met. Further, the computing device 100 may include a user interface 112 (e.g., a display) configured to indicate a communications protocol in current use and allow a user to input control for changing the communications protocol in use.

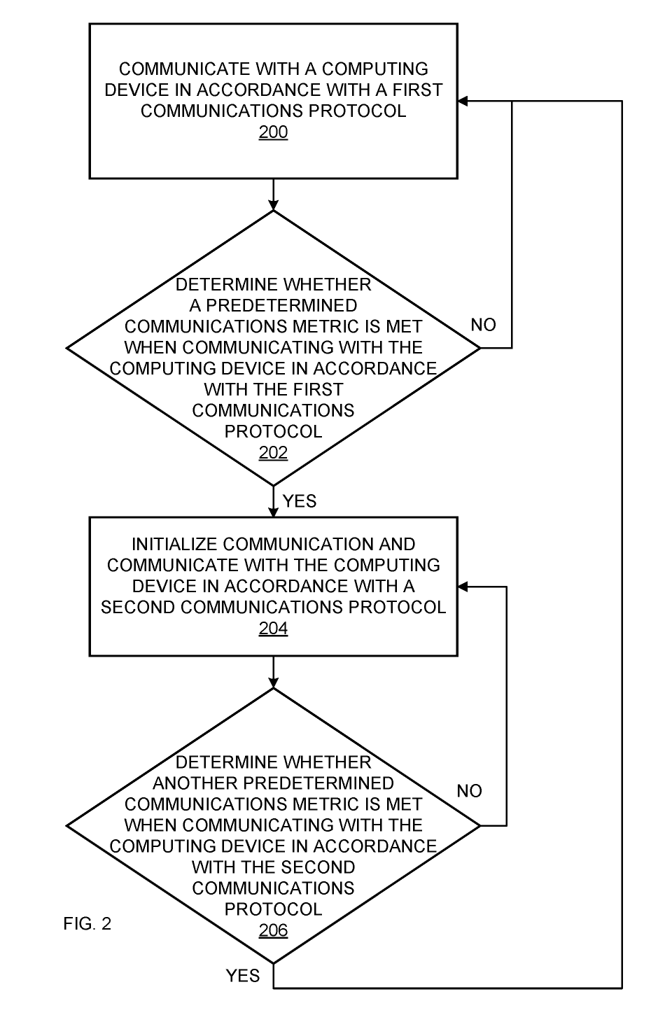

FIG. 2 illustrates a flowchart of an example method for determining communications protocol usage based on metrics according to embodiments of the present disclosure. The method is described in this example as being implemented by the computing device 100 shown in FIG. 1, although it should be understood that the method may be implemented by any suitable computing device. Particularly, the method may be implemented by the communications module 104 and the communications manager 110 shown in FIG. 1. The communications manager 100 may be implemented by suitable hardware, software, firmware, or combinations thereof In FIG. 1, the communications manager 110 is depicted as having memory 114 and one or more processors 116 for implementing the functionality described herein.

Referring to FIG. 2, the method includes communicating 200 with a computing device in accordance with a first communications protocol. For example, the computing device 100 shown in FIG. 1 may be communicating with computing device 118 for receipt of Internet-based communications from a web server 120. Computing device 118 may communicate with web server 120 via network 122, which may be the Internet. In this example, the computing device 100 may use the BLUETOOTH® module 106 via the BLUETOOTH® communications protocol. The user interface 112 may suitable present data received through the communications. For example, the user interface 112 may present a text or email notification or communication, audio streaming, video streaming, or the like.

The method of FIG. 2 includes determining 202 whether a predetermined communications metric is met when communicating with the computing device in accordance with the first communications protocol. Continuing the aforementioned example, the communications manager 110 may determine a predetermined communications metric. For example, the communications manager 110 may determine a power requirement for communicating data in accordance with the first communications protocol. The determined power requirement may be a current and/or future power requirement for communicating in accordance with the first communications protocol. The communications manager 110 may determine whether the power requirement exceeds a predetermined power level. In response to determining that the predetermined communications metric is not met, the method may return to step 200. Otherwise, the method proceeds to step 202, which is described below.

In another example of determining whether a predetermined communications metric is met, the communications manager 110 may determine an amount of data for communication in accordance with the first communications protocol exceeds a predetermined volume. In an example, the communications manager 110 may determine whether a bandwidth requirement for the communication exceeds a predetermined bandwidth threshold. In another example, the communications manager 110 may determine whether a data requirement for the communication exceeds a metric based on a number of packets of data queued to be communicated by the computing device.

In another example of determining whether a predetermined communications metric is met, the communications manager 110 may determine whether a distance to communicate with the computing device exceeds a predetermined distance. For example, the communications manager 110 may determine a distance to the computing device based on a power required for the communication. In another example, the communications manager 110 may determine the distance based on coordinates of the computing devices.

In another example of determining whether a predetermined communications metric is met, the communications manager 110 may determine whether a signal strength level during communication with the computing device in accordance with the first communications protocol is below a predetermined signal strength level.

The method of FIG. 2 includes initializing communication and communicating 204 with the computing device in accordance with a second communications protocol in response to determining that the predetermined communications metric is met. Continuing the aforementioned example, the communications manager 110 can initialize communication with the computing device 118 in accordance with another communications protocol in response to determining that the predetermined communications metric is met. For example, if the power requirement and/or data requirement for communication exceeds a particular threshold with BLUETOOTH® communication, the communications manager 110 may initialize communication with the computing device 118 using WI-FI® communication. In this example, suitable BLUETOOTH® communication with the computing device 118 may be employed for beginning the switch to WI-FI® communication. After initialization of communication in accordance with the WI-FI® protocol, the communication manager 110 may maintain communication in accordance with the WI-FI® protocol.

In an example, communication via WI-FI® protocol may be initiated by use of a WI-FI® protected setup (WPS) key.

The method of FIG. 2 includes determining 206 whether another predetermined communications metric is met when communicating with the computing device in accordance with the second communications protocol. Continuing the aforementioned example, the communications manager 110 may determine a predetermined communications metric during communication in accordance with the second communications protocol. For example, the communications manager 110 may determine a power requirement for communicating data in accordance with the second communications protocol. The determined power requirement may be a current and/or future power requirement for communicating in accordance with the second communications protocol. The communications manager 110 may determine whether the power requirement exceeds a predetermined power level. In response to determining that the predetermined communications metric is not met, the method may return to step 204. Otherwise, the method proceeds to step 200 and switch to communicating in accordance with the first communications protocol. For example, the computing device 100 may switch back to communicating in accordance with the BLUETOOTH® protocol. This may be the instance in which reduced power and/or bandwidth is needed. It is noted that any other communications metric described herein may be applied in this step 206.

Also, in response to determining that the other predetermined communications metric is met, the communications manager 110 may discontinue use of the second communications protocol for the communication.

It is noted that the computing device implemented the functionality described herein may be communicating with any suitable computing device such as, but not limited to, a smartphone, router, laptop computer, desktop computer, or the like.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
communicating with a computing device in accordance with a first communications protocol;
determining whether a predetermined communications metric is met when communicating with the computing device in accordance with the first communications protocol;
in response to determining that the predetermined communications metric is met, initializing communication with the computing device in accordance with a second communications protocol.

2. The method of claim 1, wherein the first communications protocol is BLUETOOTH® communications protocol, and
wherein the second communications protocol is WI-FI® communications protocol.

3. The method of claim 1, wherein power required by the second communications protocol is greater than power required by the first communications protocol.

4. The method of claim 1, wherein communicating with a computing device comprises communicating with one of a personal computer and a router in accordance with the first communications protocol.

5. The method of claim 1, wherein the steps of communicating, determining, and initializing are implemented at a smartphone.

6. The method of claim 1, wherein determining whether a predetermined communications metric is met comprises determining whether a power requirement for communicating in accordance with the first communications protocol exceeds a predetermined power level.

7. The method of claim 1, wherein determining whether a predetermined communications metric is met comprises determining whether an amount of data for communication in accordance with the first communications protocol exceeds a predetermined volume.

8. The method of claim 1, wherein determining whether a predetermined communications metric is met comprises determining whether a bandwidth requirement for communication with the computing device in accordance with the first communications protocol exceeds a predetermined bandwidth threshold.

9. The method of claim 1, wherein determining whether a predetermined communications metric is met comprises determining whether a distance to communicate with the computing device exceeds a predetermined distance.

10. The method of claim 1, wherein determining whether a predetermined communications metric is met comprises determining whether a signal strength level during communication with the computing device in accordance with the first communications protocol is below a predetermined signal strength level.

11. The method of claim 1, wherein initializing communication comprises communicating with the computing device in accordance with the first communications protocol to establish a secure communications environment in accordance with the second communications protocol.

12. The method of claim 11, wherein initializing communication comprises establishing the secure communications environment by use of a WI-FI® protected setup (WPS) key.

13. The method of claim 1, wherein the predetermined communications metric is a first predetermined communications metric, and
wherein further the method further comprises:
communicating with the computing device in accordance with the second communications protocol;
determining whether a second predetermined communications metric is met when communicating with the computing device in accordance with the second communications protocol;
in response to determining that the second predetermined communications metric is met:
communicating with the computing device in accordance with the first communications protocol; and
discontinuing communication with the computing device in accordance with the second communications protocol.

14. The method of claim 13, wherein the first communications protocol is BLUETOOTH® communications protocol, and
wherein the second communications protocol is WI-FI® communications protocol.

15. A computing device comprising:
a communications module configured to communicate with another computing device in accordance with a first communications protocol and a second communications protocol; and
a communications manager configured to:
determine whether a predetermined communications metric is met when communicating with the computing device in accordance with the first communications protocol; and
initialize communication with the computing device in accordance with a second communications protocol in response to determining that the predetermined communications metric is met.

16. The computing device of claim 15, wherein the first communications protocol is BLUETOOTH® communications protocol, and
wherein the second communications protocol is WI-FI® communications protocol.

17. The computing device of claim 15, wherein the communications manager is configured to determine whether a power requirement for communicating in accordance with the first communications protocol exceeds a predetermined power level.

18. The computing device of claim 15, wherein the communications manager is configured to determine whether an amount of data for communication in accordance with the first communications protocol exceeds a predetermined volume.

19. The computing device of claim 15, wherein the communications manager is configured to determine whether a bandwidth requirement for communication with the computing device in accordance with the first communications protocol exceeds a predetermined bandwidth threshold.

20. The computing device of claim 15, wherein the communications manager is configured to determine whether a signal strength level during communication with the computing device in accordance with the first communications protocol is below a predetermined signal strength level.
